(19) United States
(12) Patent Application Publication
(10) Pub. No.: US 2009/0234930 A1
(43) Pub. Date: Sep. 17, 2009

(54) E-MAIL RELAY SYSTEM AND METHOD OF CONTROLLING E-MAIL RELAY SYSTEM

(75) Inventors: Takashi TANIFUJI, Kawasaki (JP); Yoshihiro KIMURA, Kawasaki (JP); Ikuko TACHIBANA, Kawasaki (JP); Toshiaki HAYASHI, Kawasaki (JP); Yasutaka TANIKAWA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/404,561

(22) Filed: Mar. 16, 2009

(30) Foreign Application Priority Data
Mar. 17, 2008 (JP) 2008-068471

(51) Int. Cl. G06F 15/16

(52) U.S. Cl. 709/206

(57) ABSTRACT

An e-mail relay system including a first information processing apparatus that receives a first e-mail with a first identifier and stores the received first e-mail in a first storage device and notifies the first identifier to a second information processing apparatus, and the second information processing apparatus receives a second e-mail with a second identifier and stores the received second e-mail in a second storage device with the second identifier, and compares the first identifier notified with the second identifier stored in the second storage device, and extracts the second e-mail having the second identifier same with the unnotified first identifier from the second storage device, then transfers the extracted second e-mail to the first information processing apparatus.

### CROSS-REFERENCE TO RELATED APPLICATIONS

This application is based upon and claims priority to prior Japanese Patent Application No. 2008-68471 filed on Mar. 17, 2008 in the Japan Patent Office, the entire contents of which are incorporated herein by reference.

### FIELD

Various embodiments of the invention discussed herein relate to an e-mail relay system and a method of controlling an e-mail relay system.

### BACKGROUND

For example, a so-called remote support center that has the function of remotely maintaining and managing information processing systems (hereinafter, referred to as customer systems) delivered to customers utilizes, for example, e-mails as a communication tool to acquire information that indicates the current status, or the like, of the customer systems.

In this case, a plurality of multiplexed systems operate in the remote support center, and each of the plurality of systems receives and processes e-mails transmitted from the customer systems.

In the above remote support center, for the purpose of maintenance of hardware, revision of firmware, or the like, some works may needs a shutdown of any one of the plurality of multiplexed systems.

In such a case, during a system shutdown, it is impossible for the multiplexed system to receive e-mails transmitted from the customer systems. Thus, among the plurality of systems, only that system is not able to receive e-mails transmitted from the customer systems, and, after recovery of that system, integrity of the e-mails received from the customer systems collapses between that system and the other systems among the plurality of systems.

In order to prevent the above situation, when the work that needs a system shutdown as described above is conducted, it is preferable to take measures beforehand for maintaining integrity of e-mails received from the customer system.

FIG. 1 is a view that illustrates an embodiment of an existing example for maintaining integrity of e-mails.

In the embodiment depicted in FIG. 1, in the remote support center, e-mails transmitted from the customer systems are relayed by a mail relay server 100′ and transferred to a system one 210′ and a system two 220′.

In each of the systems 210′ and 220′, the transferred e-mails are once stored in a mail box 212′ or 222′, processed by an application 211′ or 221′ and then the content of the e-mails is stored in a database 213′ or 223′.

In the embodiment depicted in FIG. 1, in the remote support center, a temporary mail box 101′ is generated for the system one 210′, which may be shut down, in the mail relay server 100′ that relays e-mails transmitted from the customer systems(step 1).

When the system one 210′ is in shutdown and is not able to receive e-mails relayed by the mail relay server 100′, the mail relay server 100′ interrupts transmission of e-mails that may be relayed to the destination during that time, and stores the e-mails in the temporary mail box 101′ (step 2).

After recovery of the system one 210′ from the system shutdown, the mail relay server 100′ resumes transmission of the e-mails stored in the temporary mail box 101′ to the system one 210′ (step 3).

After all the e-mails stored in the temporary mail box 101′ are transferred to the system one 210′, the mail relay server 100′ resets the destination of e-mails to the system one 210′ (step 4).

Note that the above steps 1 to 4 all are executed by a switching operation conducted by the operator.

In the configuration depicted in FIG. 1, at the time of operation in step 2, there is a possibility that, depending on a timing between system shutdown and switching operation of the transmission destination, e-mails that have already transferred to the system one 210′ may not be received by the system one 210′ due to system shutdown and, therefore, the e-mails may be lost.

In addition, when the operation in step 4 is conducted during reception of e-mails, e-mails that might be received cannot be received during that time and, therefore, the e-mails may be lost.

FIG. 2 is a view that illustrates an existing example.

In the existing example depicted in FIG. 2, in the remote support center, e-mails transmitted from the customer systems are relayed by a mail relay server 100″ and transferred to a system one 210″ and a system two 220″. In each of the systems 210″ and 220″, the transferred e-mails are once stored in a mail box 212″ or 222″, processed by an application 211″ or 221″ and then the content of the e-mails is stored in a database 213″ or 223″.

In the case of the existing example depicted in FIG. 2, an operator, such as a system administrator, records a period of time A during which the system one 210″ is in shutdown (step 1). Then, when the system one 210″ recovers, the operator transfers e-mails, which are stored in a mail box of the system two 220″ by the time the system one 210″ recovers from the period of time A, to the system one 210″ (step 2).

Note that in the case of the existing example depicted in FIG. 2, the steps 1 and 2 all are conducted by the operator.

In the existing example depicted in FIG. 2, the period of time A cannot be accurately recorded in the operation in step 1, and there is a possibility that transfer of e-mails that are transmitted just after the start of the period of time A or just before the end of the period of time A and that might be originally transferred to the system one 210″ in step 2 may possibly be omitted.

In addition, in the existing example depicted in FIG. 2, when the applicable e-mails are extracted in the operation in step 2, there is a possibility that wrong e-mails may be extracted.

Patent Document 1: Japanese Laid-open Patent Publication No. 2004-21823

Patent Document 2: Japanese Laid-open Patent Publication No. 6-311673

### SUMMARY

An e-mail relay system including a first information processing apparatus, a second information processing apparatus, and a relay apparatus that receives one or more first e-mails with one or more respective first identifiers and relays the one or more first e-mails to the first information processing apparatus, and receives one or more second e-mails that are identical to the one or more first emails and have one or more second identifiers that are identical to the one or more first identifiers and relays the one or more second e-mails to the second information processing apparatus. The first information processing apparatus receives the one or more first e-mails with the one or more first identifiers, stores the received one or more first e-mails in a first storage device, and notifies the one or more first identifiers to the second information processing apparatus. The second information processing apparatus receives the one or more second e-mails with the one or more second identifiers, stores the received one or more second e-mails in a second storage device with the one or more second identifiers, compares the one or more first identifiers notified by the first information processing apparatus with the one or more second identifiers stored in the second storage device, and extracts a second e-mail having a second identifier that is the same as an unnotified first identifier from the second storage device and then transfers the extracted second e-mail to the first information processing apparatus.

### BRIEF DESCRIPTION OF DRAWINGS

FIG. 1 is a view that illustrates an existing example of an e-mail relay system.

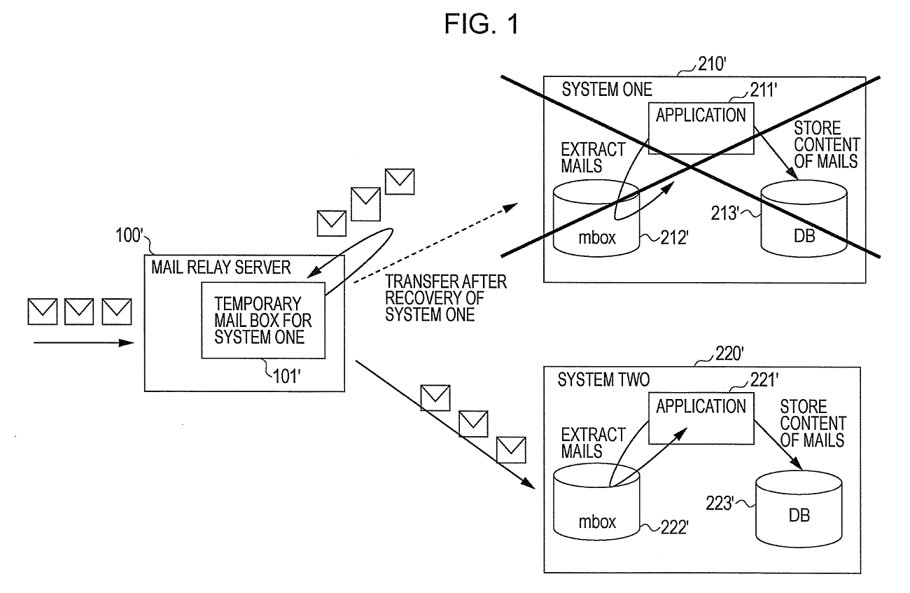

FIG. 2 is a view that illustrates another existing example of an e-mail relay system.

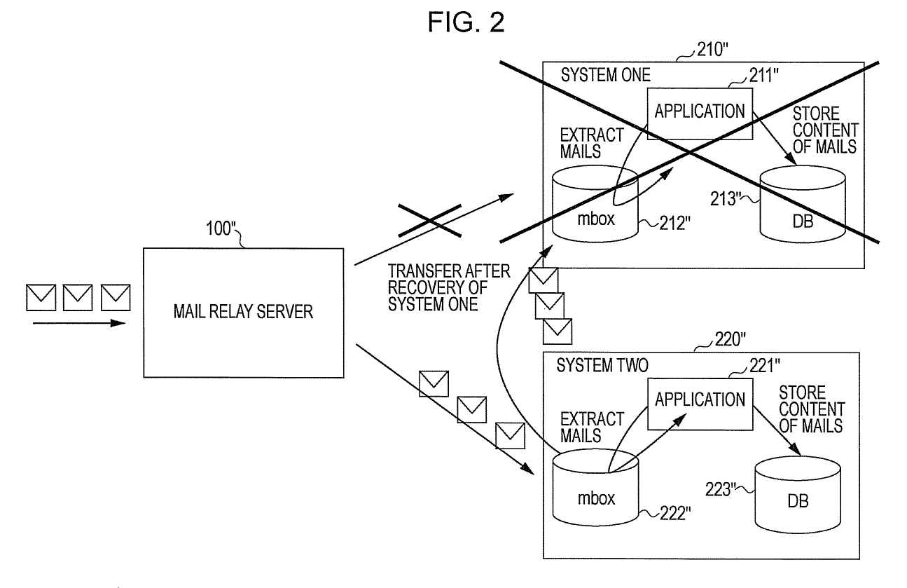

FIG. 3 is a block diagram that illustrates the configuration of an e-mail relay system that implements an e-mail relay system and method of controlling an e-mail relay system according to a first embodiment.

FIG. 4 is a flowchart that illustrates the process flow in the e-mail relay system depicted in FIG. 3.

FIG. 5 is a block diagram that illustrates the configuration of an e-mail relay system that implements an e-mail relay system and method of controlling an e-mail relay system according to a second embodiment.

FIG. 6 is a block diagram that illustrates the configuration of an e-mail relay system that implements an e-mail relay system and method of controlling an e-mail relay system according to a third embodiment.

FIG. 7 is a flowchart that illustrates the process flow in the e-mail relay system depicted in FIG. 6.

FIG. 8 is a block diagram that illustrates the configuration of devices that constitute the e-mail relay system according to the first embodiment.

FIG. 9 is a block diagram that illustrates the configuration of devices that constitute the e-mail relay system according to the second embodiment.

FIG. 10 is a block diagram that illustrates the configuration of devices that constitute the e-mail relay system according to the third embodiment.

FIG. 11 is a view that illustrates a field of application of the embodiments.

FIG. 12 is a sequence diagram that illustrates an actual example of the exchange of information between the systems in the embodiments.

FIG. 13 is a block diagram that illustrates an actual example of a method and control of assigning identifiers in the mail relay server in the embodiments.

FIG. 14 is a hardware block diagram of a computer illustrating that devices that constitute the embodiments are formed of the computer.

### DESCRIPTION OF EMBODIMENTS

In this embodiment, when e-mails are relayed from a mail relay server that serves as a relay device that relays e-mails, to each system that serves as an information processing apparatus, sequential identifiers (hereinafter, referred to as “id's” where appropriate) are assigned to the e-mails and then the e-mails are transferred. Thus, according to the e-mail relay system and method of controlling an e-mail relay system of the present embodiment, it is possible to maintain integrity of e-mails held respectively by multiplexed systems that continuously operate 24 hours a day, 365 days a year.

Each system stores sequential id's, transferred from the mail relay server in a DB, and exchanges information regarding the id's with the other systems.

As a result, even when any system is disabled to receive e-mails relayed by the mail relay server and, therefore, some e-mails are temporarily omitted from among the e-mails held by the system itself, the presence of omitted e-mails among the e-mails held in each system is checked one another by exchanging the id information. Thus, even when any system is disabled to receive e-mails, that is, when any system is in system shutdown due to scheduled maintenance work, occurrence of a trouble, or the like, missing e-mails may be received from the other systems.

In this way, with the disclosed e-mail relay system and method of controlling an e-mail relay system, integrity of the e-mails held by the systems is automatically checked, and a missing e-mail is compensated. Thus, it is possible to ensure integrity of the e-mails held by the systems.

Moreover, according to the e-mail relay system and method of controlling an e-mail relay system of the present embodiment, even when the systems that receive e-mails relayed from the mail relay server are physically located remotely from one another, it is possible to ensure integrity of the held e-mails. Thus, the e-mail relay system and method of controlling an e-mail relay system according to the present embodiment may also be applied when a system is installed at a remote location for disaster control, or the like. Hence, it is possible to provide a system that is able to implement early restoration in the event of a disaster.

Embodiments are schematically described as follows.

A first embodiment is an embodiment of a so-called single server, and the single mail relay server relays e-mails.

A second embodiment is an embodiment of a so-called cluster, and two mail relay servers are provided. One of the two mail relay servers is in operation, and the other one is in standby (so-called hot standby) to enhance reliability of the mail relay servers.

A third embodiment is an embodiment of a so-called load balancing configuration. The amount of e-mails transmitted to the mail relay servers and the status of each of the relay destination two systems are considered to thereby distribute a processing load executed by the systems.

Hereinafter, the above embodiments of the invention will be described in detail with reference to the accompanying drawings.

First, the e-mail relay system and method of controlling an e-mail relay system according to the first embodiment will be described.

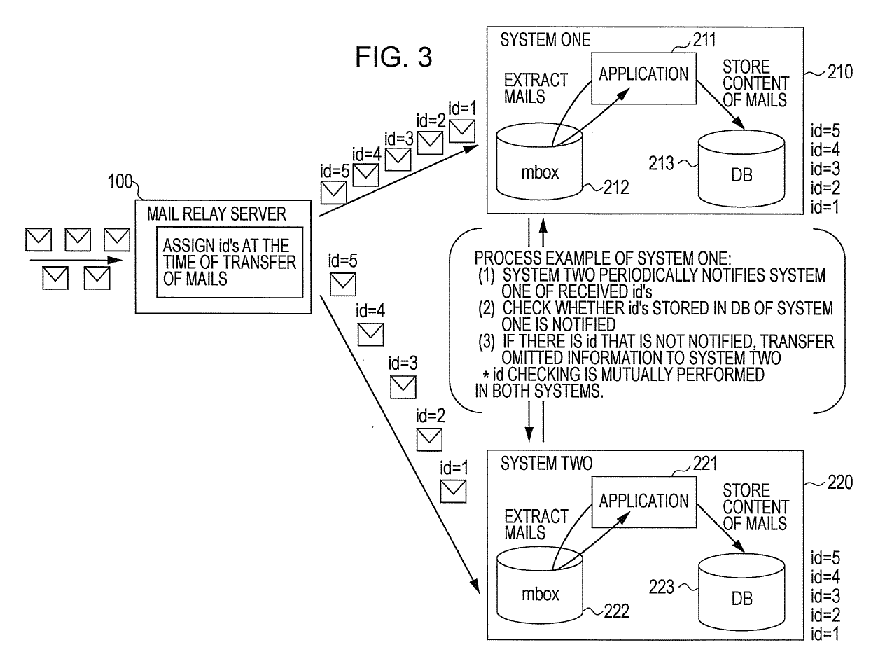

FIG. 3 is a block diagram that illustrates the configuration that implements the e-mail relay system and method of controlling an e-mail relay system according to the first embodiment.

As depicted in FIG. 3, in the configuration that implements the e-mail relay system and method of controlling an e-mail relay system according to the first embodiment, that is, a single-server e-mail relay system, a single mail relay server 100 is provided to relay e-mails and transfer the e-mails to a system one 210 and a system two 220, which serve as information processing apparatuses that receive and process the e-mails.

In each of these systems 210 and 220, the thus transferred e-mails are once stored in a mail box 212 or 222, processed by an application 211 or 221, and then the content of each e-mail is stored in a database 213 or 223.

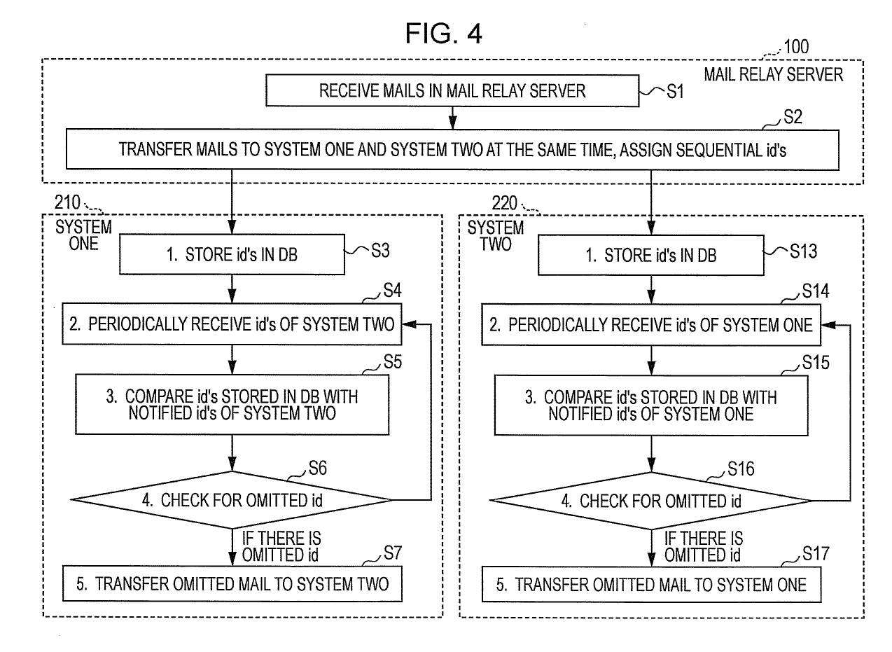

FIG. 4 is a flowchart that illustrates the process flow in the e-mail relay system of the configuration depicted in FIG. 3.

In FIG. 4, when the mail relay server 100 receives e-mails transmitted from customer systems (step S1), the mail relay server 100 relays the e-mails and transfers the e-mails to the system one 210 and the system two 220 (step S2).

Here, when the mail relay server 100 relays the e-mails transmitted from the customer system, the mail relay server 100 transfers the e-mails to the system one 210 and also transfers e-mails having the same content as the e-mails transferred to the system one 210 to the system two 220.

That is, two e-mails having the same content are respectively generated, one of two e-mails (referred to as first e-mails) are transferred to the system one 210, and the other one (referred to as second e-mails) are transferred to the system two 220.

Note that in step S2, when the mail relay server 100 transfers the e-mails to the system one 210 and the system two 220 as described above, the mail relay server 100 assigns the same sequential identifiers id's to both e-mails (that is, first e-mails and second e-mails). As a result, the first and second e-mails having the same id have the same content.

When the system one 210 receives the e-mails transferred from the mail relay server 100 in this way, the system one 210 stores the received e-mails in the database 213 together with id's assigned to the e-mails by the mail relay server 100 as described above (step S3). In addition, the system one 210 periodically transmits the id's stored in the database 213 to the other system two 220 for notification.

Similarly, when the system two 220 receives the e-mails transferred from the mail relay server 100 as described above, the system two 220 stores the received e-mails in the database 223 together with the id's assigned to the e-mails by the mail relay server 100 as described above (step S13). In addition, the system two 220 periodically transmits the id's stored in the database 223 to the other system one 210 for notification.

In step S4, the system one 210 receives the id's that are stored in the database 223 of the other system two 220 and periodically transmitted from the other system two 220 as described above.

Similarly, in step S14, the system two 220 receives the id's that are stored in the database 213 of the other system one 210 and periodically transmitted from the other system one 210 as described above.

In step S5, the system one 210 compares the id's received from the other system two 220 in step S4 with the id's stored in the database 213 in step S3, and checks whether the id's that respectively coincide with all the id's stored in the database 213 are received from the other system two 220 (step S6).

As a result of checking in step S6, if there is an id corresponding to any one of the id's stored in the database 213 but not received from the other system two 220 (hereinafter, this state is referred to as “omitted” state), the system one 210 extracts the e-mail having the corresponding id from the database 213 and transfers that e-mail to the other system two 220 (step S7).

Similarly, in step S15, the system two 220 compares the id's received from the other system one 210 in step S14 with the id's stored in the database 223 in step S13, and checks whether the id's that respectively coincide with all the id's stored in the database 223 are received from the other system one 210 (step S16).

As a result of checking in step S16, if there is an id corresponding to any one of the id's stored in the database 223 but not received from the other system one 210 (that is, the “omitted” state), the system two 220 extracts the e-mail having the corresponding id from the database 223 and transfers that e-mail to the other system one 210 (step S1 7).

Here, when the mail relay server 100 receives an e-mail from the customer system, the mail relay server 100 generates two e-mails having the same content as described above, that is, the first e-mail and the second e-mail, assigns the same id to the first and second e-mails, and then transfers the first e-mail to the system one 210 and transfers the second e-mail to the system two 220.

In the example depicted in FIG. 3, sequential numbers 1, 2, 3, 4, 5 are sequentially assigned to the first e-mails as id's and the first e-mails are transferred to the system one 210. Similarly, the same sequential numbers 1, 2, 3, 4, 5 are also sequentially assigned to the second e-mails as id's and the second e-mails are transferred to the system two 220.

Thus, the first e-mail having id=1 has the same content as the second e-mail having id=1, the first e-mail having id=2 has the same content as the second e-mail having id=2, the first e-mail having id=3 has the same content as the second e-mail having id=3, and the same applies to the following e-mails having the same id.

Normally, that is, when both the system one 210 and the system two 220 operate normally, steps S4 to S6 are repeatedly executed in the system one 210, and, similarly, steps S14 to S16 are repeatedly executed in the system two 220.

That is, normally, first and second e-mails are relayed by the mail relay server 100, assigned with the same sequential numbers, 1, 2, 3, 4, 5 in the example of the drawing as id's by the mail relay server as described above (step S2), and then respectively received by the system one 210 and the system two 220.

When the system one 210 receives the first e-mails, the system one 210 stores the first e-mails in the database 213 together with the corresponding id's (step S3).

Thus, in the case of the above example, id's=1, 2, 3, 4, 5 are stored in the database 213. Then, the system one 210 transmits these stored id's=1, 2, 3, 4, 5 to the other system two 220 for notification.

Similarly, when the system two 220 receives the second e-mails, the system two 220 stores the second e-mails in the database 223 together with the corresponding id's (step S1 3).

Thus, in the case of the above example, the id's=1, 2, 3, 4, 5 are stored in the database 223. Then, the system two 220 transmits these stored id's=1, 2, 3, 4, 5 to the other system one 210 for notification.

When the system one 210 receives id's=1, 2, 3, 4, 5 of the second e-mails transmitted from the system two 220 in this way, the system one 210 checks whether all id's that respectively coincide with id's=1, 2, 3, 4, 5 of the first e-mails stored in the database 213, are received from the system two 220 (steps S4, S5, S6).

Here, normally, as described above, the system one 210 and the system two 220 are able to respectively receive all the first and second e-mails, so all the second e-mails having the same content as the first e-mails received by the system one 210 are also received by the system two 220. Thus, id's=1, 2, 3, 4, 5 of the respective first e-mails received by the system one 210 all coincide with id's=1, 2, 3, 4, 5 of the respective second e-mails received by the system two 220.

As a result, the system one 210 receives all id's that respectively coincide with id's=1, 2, 3, 4, 5 of the first e-mails stored in the database 213 from the system two 220.

Thus, in this case, in the checking in step S6, the system one 210 determines that id's that respectively coincide with all the id's stored in the database 213 are received from the other system two 220 (hereinafter, this state is referred to as “non-omitted” state), the system one 210 returns to step S4, and then repeatedly executes steps S4 to S6 until it is determined to be the “omitted” state in step S6.

Similarly, when the system two 220 receives id's=1, 2, 3, 4, 5 of the first e-mails, transmitted from the system one 210 as described above, the system two 220 checks whether all id's that respectively coincide with id's=1, 2, 3, 4, 5 of the second e-mails stored in the database 223 are received from the system one 210 (steps S14, S15, S16).

Here, normally, as described above, the system one 210 and the system two 220 are able to respectively receive all the first and second e-mails, so all the first e-mails having the same content as the second e-mails received by the system two are also received by the system one 210. Thus, id's=1, 2, 3, 4, 5 of the respective second e-mails received by the system two 220 all coincide with id's=1, 2, 3, 4, 5 of the respective first e-mails received by the system one 210.

As a result, the system two 220 receives all id's that respectively coincide with id's=1, 2, 3, 4, 5 of the second e-mails stored in the database 223 from the system one 210.

Thus, in this case, in the checking in step S16, the system two 220 determines that id's that respectively coincide with all id's stored in the database 223 are received from the other system one 210 (that is, the “non-omitted” state), the system two 220 returns to step S14, and then repeatedly executes steps S14 to S16 until it is determined to be the “omitted” state in step S16.

Next, it is assumed that under abnormal conditions, that is, when one of the system one 210 and the system two 220 is shutdown because of any reason and is not able to receive e-mails transferred from the mail relay server 100.

Here, as an example, it is assumed that the system two 220 temporarily enters the shutdown state and, after that, is recovered, and, as a result, the second e-mail having id=3 is not received among the second e-mails having id's=1, 2, 3, 4, 5, transferred from the mail relay server as described above.

In this case, the system two 220 stores the received second e-mails having id's=1, 2, 4, 5 in the database 223 together with id's=1, 2, 4, 5 (step S13) and transmits these id's=1, 2, 4, 5 to the other system one 210 for notification.

On the other hand, the system one 210 normally operates during that time. Thus, the system one 210 receives all the first e-mails having id's=1, 2, 3, 4, 5 transmitted from the mail relay server 100, and stores the received first e-mail having id's=1, 2, 3, 4, 5 in the database 213 together with those id's=1, 2, 3, 4, 5 (step S3).

Then, the system one 210 checks whether all id's=1, 2, 3, 4, 5 that respectively coincide with id's=1, 2, 3, 4, 5 stored in the database 213 in this way are received from the other system two 220 (steps S5, S6).

Because id's=1, 2, 4, 5 are received from the other system two 220 as described above and id=3 is omitted (that is, missing), it is determined in the checking in step S6 to be the “omitted” state.

In this case, the system one 210 proceeds to step S7, extracts the e-mail having the missing id=3 from the database 213 and then transfers the extracted e-mail to the other system two 220.

With the result that the missing e-mail is transferred to the system two 220, the e-mail having the same content as the e-mail having id=3, which cannot be received from the mail relay server 100 because of the system shutdown, is transferred from the system one 210 to the system two 220 in this way.

With the result that the e-mail is transferred to the system two 220, the system two 220 compensates for the second e-mail having id=3, which cannot be received because of the system shutdown, among the second e-mails having id's=1, 2, 3, 4, 5 transferred from the mail relay server 100.

As a result, the system one 210 holds the first e-mails having id's=1, 2, 3, 4, 5, transferred from the mail relay server 100, while the system two 220 holds the second e-mails having id's=1, 2, 4, 5, transferred from the mail relay server 100, and the e-mail having the same content as the first e-mail having id=3, which is transferred from the system one 210 for compensation as described above.

Thus, both the system one 210 and the system two 220 hold the e-mails having id's=1, 2, 3, 4, 5, so the integrity between the e-mails held by both the system one 210 and the system two 220 is ensured.

Note that in the case of the above assumed example, after the system two 220 recovers from the system shutdown, because the e-mails received by both the system one 210 and the system two 220 from the mail relay server as described above, that is, the first e-mails and the second e-mails, mutually have the same id's, the “non-omitted” state is maintained. Thus, the system one 210 repeatedly executes steps S4 to S6, and the system two 220 repeatedly executes steps S14 to S16.

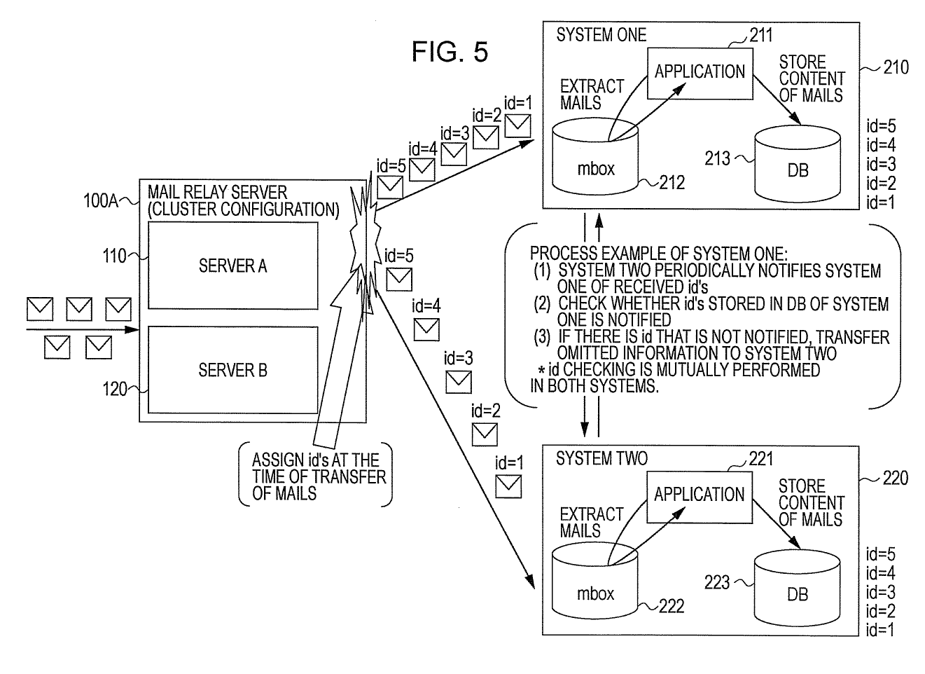

Next, the e-mail relay system and method of controlling an e-mail relay system according to the second embodiment will be described with reference to FIG. 5.

In this case, as depicted in the drawing, in a mail relay server 100A, two systems having a similar configuration, that is, a server A 110 and a server B 120, are provided, and one (that is, a primary system and a main system) server is operated, while the other (that is, a standby system and a spare system) server processes the same operations as the one server while being in standby. That is, a so-called hot standby mode is employed.

In the case of the second embodiment, the server A 110 or the server B 120 provides a similar function to that of the mail relay server 100 in the above first embodiment, the other configuration is similar to that of the first embodiment, and the operations are also similar to those of the first embodiment described with reference to FIG. 4. In FIG. 5, like reference numerals denote like components to those depicted in FIG. 3, and the overlapping description is omitted.

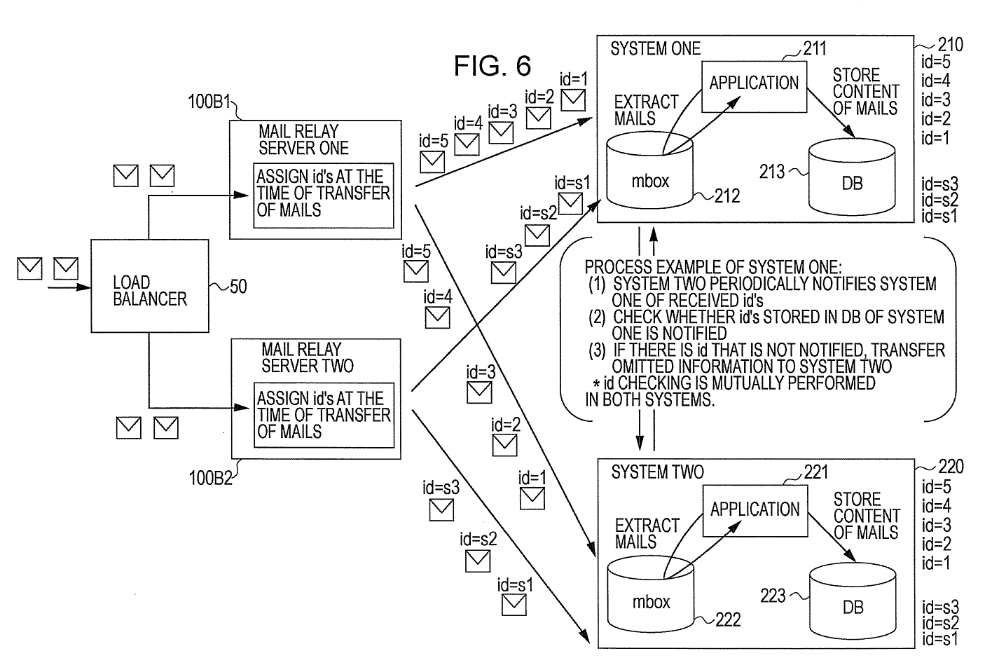

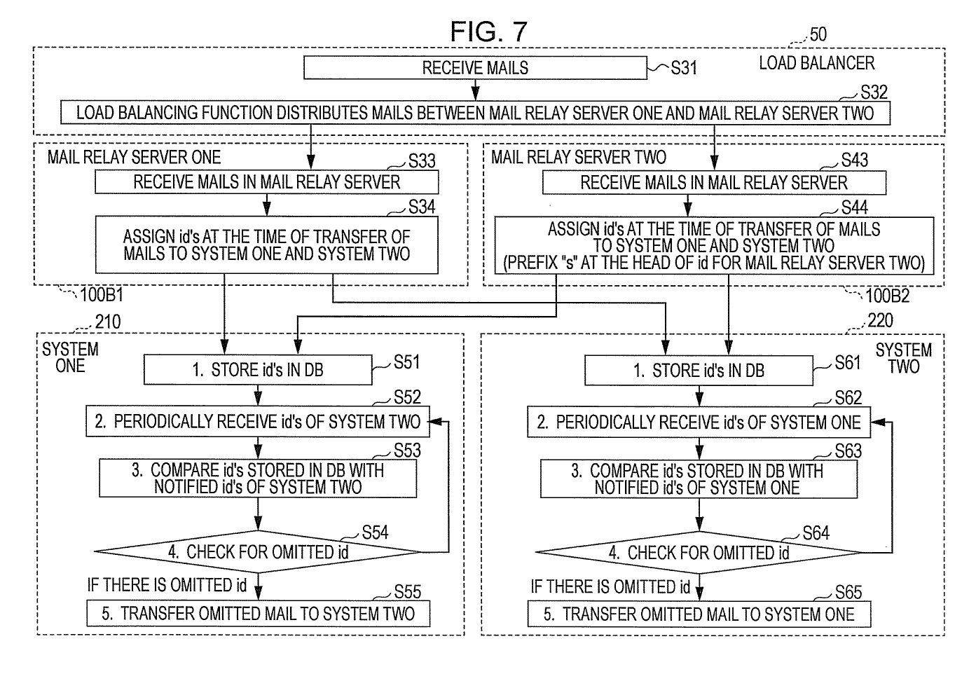

Next, the e-mail relay system and method of controlling an e-mail relay system according to the third embodiment will be described with reference to FIG. 6 and FIG. 7.

FIG. 6 depicts the system configuration that implements the e-mail relay system and method of controlling an e-mail relay system according to the third embodiment.

As depicted in FIG. 6, the e-mail relay system and method of controlling an e-mail relay system according to the third embodiment includes a load balancer 50 that receives e-mails from customer systems, and two mail relay servers, that is, a mail relay server one 100B1 and a mail relay server two 100B2, that receive e-mails from the customer systems through the load balancer 50.

The load balancer 50 distributes e-mails, received from the customer systems, between the mail relay server one 100B1 and the mail relay server two 100B2. That is, the load balancer 50 transfers the received e-mails to the mail relay server one 100B1 when a load on the mail relay server two 100B2 is high, whereas the load balancer 50 transfers the received e-mails to the mail relay server two 100B2 when a load on the mail relay server one 100B1 is high.

In this way, the load balancer 50 transfers a certain portion of e-mails, among the received e-mails, to the relay server one 100B1 and transfers the remaining portion of e-mails to the relay server two 100B2.

That is, the mail relay server one 100B1 and the mail relay server two 100B2 share and relay the e-mails in such a manner that the load balancer 50 distributes the e-mails for relay. In this manner, loads on the mail relay servers 100B1 and 100B2 are mutually distributed.

The e-mails relayed by the relay servers 100B1 and 100B2 are transferred to the system one 210 and the system two 220, both of which serve as the information processing apparatuses that receive and process the e-mails.

In each of these systems 210 and 220, the thus transferred e-mails are once stored in the mail box 212 or 222, processed by the application 211 or 221, and then the content of each e-mail is stored in the database 213 or 223.

In this way, e-mails are distributed by the load balancer 50 prior to reaching the mail relay servers 100B1 and 100B2, so the e-mails are relayed only by any one of the mail relay server one 100B1 and the mail relay server two 100B2.

Therefore, in each of the system one 210 and the system two 220 to which e-mails are relayed, it is preferable to identify by which one of the two mail relay servers 100B1 and 100B2 an e-mail is relayed.

Thus, in each of the mail relay servers 100B1 and 100B2, id's in different system of series are assigned to the e-mails relayed by itself so as to be able to discriminate by which one of the two mail relay servers 100B1 and 100B2 the e-mails are relayed.

That is, the mail relay server one 100B1 assigns first id's in different system of series to the e-mails to be relayed, and the mail relay server two 100B2 assigns second id's in different system of series, which are different from the first id's, to the e-mails to be relayed.

As an example of these first id's in different system of series and second id's in different system of series, in the third embodiment, the mail relay server two 100B2 prefixes “s” to each id, whereas the mail relay server one 100B1 does not prefix “s” to each id. That is, in this example, the first id's in different system of series are sequential numbers, and the second id's in different system of series are sequential numbers with “s” prefixed to the numbers.

With the result of receiving the e-mails to which the second id's in different system of series are assigned with “s” prefixed to each id as described above, when there occurs the “omitted” state so that the sequential numbers are not sequential in the e-mails received in each of the systems 210 and 220, it may be identified by which one of the mail relay servers 100B1 and 100B2 the missing e-mail are relayed. Thus, when a missing e-mail is transmitted to the other system, a correct e-mail may be transmitted.

Hereinafter, the process flow of the e-mail relay system and method of controlling an e-mail relay system according to the third embodiment of the invention will be described with reference to FIG. 7.

In FIG. 7, when the load balancer 50 receives e-mails from the customer systems (step S31), the load balancer 50 distributes the received e-mails to any one of the mail relay servers 100B1 and 100B2 and transfers the distributed e-mails to the mail relay servers 100B1 and 100B2 (step S32).

When the mail relay server one 100B1 receives the e-mails transferred from the load balancer 50 (step S33), the mail relay server one 100B1 relays the e-mails and transfers them to the system one 210 and the system two 220 (step S34).

Here, when the mail relay server one 100B1 relays the e-mails transferred from the load balancer 50, the mail relay server one 100B1 transfers the e-mails to the system one 210 and also transfers e-mails, having the same content as the above e-mails transferred to the system one 210, to the system two 220. That is, two e-mails having the same content are respectively generated, one of them (referred to as first e-mails) are transferred to the system one 210, and the other one (referred to as second e-mails) are transferred to the system two 220.

Note that in step S34, when the mail relay server one 100B1 transfers the e-mails to the system one 210 and the system two 220 as described above, the mail relay server one 100B1 assigns the same first systematic sequential identifiers id's to both e-mails (that is, first e-mails and second e-mails). As a result, the first and second e-mails having the same id have the same content.

Here, sequential numbers, that is, id's=1, 2, 3, 4, 5, . . . are assigned to the e-mails as the first id's in different system of series by the mail relay server one 100B1 when the mail relay server one 100B1 transfers the e-mails to the system one 210 and the system two 220.

On the other hand, when the mail relay server two 100B2 receives the e-mails transferred from the load balancer 50 (step S43), the mail relay server two 100B2 relays the e-mails and transfers them to the system one 210 and the system two 220 (step S44).

Here, when the mail relay server two 100B2 relays the e-mails transferred from the load balancer 50 as well, the mail relay server two 100B2 transfers the e-mails to the system one 210 and also transfers e-mails, having the same content as the above e-mails transferred to the system one 210, to the system two 220.

That is, the mail relay server two 100B2 respectively generates two e-mails having the same content, one of them (referred to as third e-mails) are transferred to the system one 210, and the other one (referred to as fourth e-mails) are transferred to the system two 220.

Note that in step S44, when the mail relay server two 100B2 transfers the e-mails to the system one 210 and the system two 220 as described above, the mail relay server two 100B2 assigns the same second systematic sequential identifiers id's to the e-mails (that is, third e-mails and fourth e-mails). As a result, the third and fourth e-mails having the same id have the same content.

Note that, at this time, “s” is prefixed to each of the second id's in different system of series assigned to the e-mails when the mail relay server two 100B2 transfers the e-mails to the system one 210 and the system two 220 as described above so that the e-mails may be discriminated from the e-mails relayed by the mail relay server one 100B1.

That is, sequential number with the prefix “s”, that is, id's s1, s2, s3, . . . , are assigned to the e-mails as the second id's in different system of series by the mail relay server two 100B2 when the mail relay server two 100B2 transfers the e-mails to the system one 210 and the system two 220.

When the system one 210 receives the first or third e-mails transferred from the mail relay server one 100B1 or the mail relay server two 100B2 in this way, the system one 210 stores the e-mails in the database 213 together with id's assigned to the e-mails by the mail relay server as described above (step S51). In addition, the system one 210 periodically transmits the id's stored in the database 213 in this way to the other system two 220 for notification.

Similarly, when the system two 220 receives the second or fourth e-mails transferred from the mail relay server 100B1 or 100B2 as described above, the system two 220 stores the e-mails in the database 223 together with the id's assigned to the e-mails by the mail relay server as described above (step S61). In addition, the system two 220 periodically transmits the id's stored in the database 223 in this way to the other system one 210 for notification.

In step S52, the system one 210 receives the id's that are stored in the database 223 of the other system two 220 and periodically transmitted from the other system two 220 as described above.

Similarly, in step S62, the system two 220 receives the id's that are stored in the database 213 of the other system one 210 and periodically transmitted from the other system one 210 as described above.

In step S53, the system one 210 compares the id's received from the other system two 220 in step S52 with the id's stored in the database 213 in step S51, and checks whether all the id's that respectively coincide with the id's stored in the database 213 are received from the other system two 220 (steps S53, S54).

Note that when the system one 210 compares id's in step S53, the system one 210 compares the first id's in different system of series of the second e-mails received from the other system two 220 in step S52 with the first id's in different system of series of the first e-mails stored in the database 213. In addition, similarly, in step S53, the system one 210 compares the second id's in different system of series of the fourth e-mails received from the other system two 220 in step S52 with the second id's in different system of series of the third e-mails stored in the database 213.

The system one 210 checks in step S54 whether any e-mail having the first systematic id that coincides with any one of the first id's in different system of series stored in the database 213 is not received from the other system two 220. When there is the e-mail that is not received from the system two 220, the system one 210 extracts the first e-mail having the corresponding first systematic id from the database 213 and transfers the first e-mail to the other system two 220 (step S55).

In addition, the system one 210 checks in step S54 whether any e-mail having the second systematic id that coincides with any one of the second id's in different system of series stored in the database 213 is not received from the other system two 220. When there is an e-mail that is not received from the system two 220, the system one 210 extracts the third e-mail having the corresponding second systematic id from the database 213 and transfers the third e-mail to the other system two 220 (step S55).

Similarly, in step S62, the system two 220 compares the id's received from the other system one 210 in step S61 with the id's stored in the database 223 in step S61. Then, the system two 220 checks whether all the id's that respectively coincide with the id's stored in the database 223 are received from the other system one 210 (steps S63, S64).

Note that when the system two 220 compares id's in step S63, the system two 220 compares the first id's in different system of series of the first e-mails, received from the other system one 210 in step S62, with the first id's in different system of series of the second e-mails, stored in the database 223. In addition, similarly, in step S63, the system two 220 compares the second id's in different system of series of the third e-mails, received from the other system one 210 in step S62, with the second id's in different system of series of the fourth e-mails, stored in the database 223.

The system two 220 checks in step S64 whether any e-mail having the first systematic id that coincides with any one of the first id's in different system of series stored in the database 223 is not received from the other system one 210. When there is the e-mail that is not received from the system one 210, the system two 220 extracts the second e-mail having the corresponding first systematic id from the database 223 and transfers the second e-mail to the other system one 210 (step S65).

In addition, the system two 220 checks in step S64 whether any e-mail having the second systematic id that coincides with any one of the second id's in different system of series stored in the database 223 is not received from the other system one 210. When there is an e-mail that is not received from the system one 210, the system two 220 extracts the fourth e-mail having the corresponding second systematic id from the database 223 and transfers the fourth e-mail to the other system one 210 (step S65).

Here, when each of the mail relay servers 100B1 and 100B2 receives e-mails from the load balancer 50, each of the mail relay servers 100B1 and 100B2 generates two e-mails having the same content as described above, that is, the first e-mails and the second e-mails or the third e-mails and the fourth e-mails. Subsequently, the mail relay server one 100B1 assigns the same first id's in different system of series to the first and second e-mails, and the mail relay server two 100B2 assigns the same second id's in different system of series to the third and fourth e-mails.

In the example depicted in FIG. 7, the mail relay server one 100B1 sequentially assigns sequential numbers 1, 2, 3, 4, 5 to the first e-mails as the first id's in different system of series and then transfers them to the system one 210. In addition, similarly, the mail relay server one 100B1 also sequentially assigns the same sequential numbers 1, 2, 3, 4, 5 to the second e-mails as the first id's in different system of series and then transfers them to the system two 220.

Thus, the first e-mail having id=1 has the same content as the second e-mail having id=1, the first e-mail having id=2 has the same content as the second e-mail having id=2, the first e-mail having id=3 has the same content as the second e-mail having id=3, and the same applies to the following e-mails having the same id.

Similarly, the mail relay server two 100B2 sequentially assigns sequential numbers with the prefix “s” to the third e-mails as the second id's in different system of series and transfers them to the system one 210. In addition, the mail relay server two 100B2 sequentially assigns the same sequential numbers with the prefix “s” to the fourth e-mails as the second id's in different system of series and transfers them to the system two 220.

Thus, the third e-mail having id=s1 has the same content as the fourth e-mail having id=s1, the third e-mail having id=s2 has the same content as the fourth e-mail having id=s2, and the third e-mail having id=s3 has the same content as the fourth e-mail having id=s3.

Here, when both the system one 210 and the system two 220 operate normally, steps S52 to S54 are repeatedly executed in the system one 210, and, similarly, steps S62 to S64 are repeatedly executed in the system two 220.

That is, normally, the same sequential numbers 1, 2, 3, 4, 5 are assigned as the first id's in different system of series by the mail relay server one 100B1 to the e-mails having the same content, relayed by the mail relay server one 100B1, as described in step S34. Then, the first and second e-mails assigned with the first id's in different system of series by the mail relay server are respectively received by the system one 210 and the system two 220.

Similarly, the same sequential numbers with the prefix “s”, that is, s1, s2, s3, are assigned as the second id's in different system of series by the mail relay server two 100B2 to the e-mails having the same content, relayed by the main relay server two 100B2, as described in step S44. Then, the third and fourth e-mails assigned with the second id's in different system of series by the mail relay server are respectively received by the system one 210 and the system two 220.

When the system one 210 receives the first e-mails or the third e-mails, the system one 210 stores the e-mails in the database 213 together with the first id's in different system of series or the second id's in different system of series (step S51). Thus, in the case of the above example, id's=1, 2, 3, 4, 5 or id's=s1, s2, s3 are stored in the database 213. Then, the system one 210 transmits these stored id's=1, 2, 3, 4, 5 or id's=s1, s2, s3 to the other system two 220 for notification.

Similarly, when the system two 220 receives the second e-mails or the fourth e-mails, the system two 220 stores the e-mails in the database 223 together with the first id's in different system of series or the second id's in different system of series (step S61). Thus, in the case of the above example, id's=1, 2, 3, 4, 5 or id's=s1, s2, s3 are stored in the database 223. Then, the system two 220 transmits these stored id's=1, 2, 3, 4, 5 or id's=s1, s2, s3 to the other system one 210 for notification.

The system one 210 receives the first id's in different system of series=1, 2, 3, 4, 5 of the second e-mails or the second id's in different system of series=s1, s2, s3, transmitted from the system two 220 in this way. Then, the system one 210 checks whether all id's that respectively coincide with the first id's in different system of series=1, 2, 3, 4, 5 of the first e-mails and the second id's in different system of series=s1, s2, s3 of the third e-mails, which are stored in the database 213, are received from the system two 220 (steps S52, S53, S54).

Here, normally, as described above, the system one 210 and the system two 220 are respectively able to receive all the first and second e-mails or all the third and fourth e-mails. Therefore, all the second e-mails or the fourth e-mails having the same content as the first e-mails or the third e-mails, received by the system one 210, are also received by the system two 220. Thus, all the first id's in different system of series of the first e-mails received by the system one 210 or all the second id's in different system of series of the third e-mails received by the system one 210 respectively coincide with all the first id's in different system of series of the second e-mails received by the system two 220 or all the second id's in different system of series of the fourth e-mails received by the system two 220.

As a result, in the system one 210, all id's that respectively coincide with the first id's in different system of series=1, 2, 3, 4, 5 of the first e-mails or the second id's in different system of series=s1, s2, s3 of the third e-mails, which are stored in the database 213, are received from the system two 220.

Thus, in the checking in step S54, it is determined that the system one 210 receives the first id's in different system of series that respectively coincide with all the first id's in different system of series stored in the database 213 from the other system two 220 and, in addition, the second id's in different system of series that respectively coincide with all the second id's in different system of series stored in the database 213 are received from the other system two 220 (that is, “non-omitted” state).

In this case, the process returns to step S52, and, thereafter, steps S52 to S54 are repeatedly executed until it is determined in step S54 to be the “omitted” state because id numbers are not sequential.

Similarly, when the system two 220 receives the first id's in different system of series of the first e-mails or the second id's in different system of series of the third e-mails, transmitted from the system one 210 as described above, the system two 220 checks whether all id's that respectively coincide with the first id's in different system of series of the second e-mails or the second id's in different system of series of the fourth e-mails, stored in the database 223, are received from the system one 210 (steps S62, S63, S64).

Here, normally, as described above, the system one 210 and the system two 220 are respectively able to receive all the first and second e-mails or all the third and fourth e-mails.

Therefore, all the first e-mails or the third e-mails having the same content as the second e-mails or the fourth e-mails, received by the system two 220, are also received by the system one 210. Thus, all the first id's in different system of series of the second e-mails received by the system two 220 or all the second id's in different system of series of the fourth e-mails received by the system two 220 respectively coincide with all the first id's in different system of series of the first e-mails received by the system one 210 or all the second id's in different system of series of the third e-mails received by the system one 210.

As a result, in the system two 220, all the first id's in different system of series that respectively coincide with the first id's in different system of series of the second e-mails, stored in the database 223, are received from the system one 210, and, in addition, all the second id's in different system of series that respectively coincide with the second id's in different system of series of the fourth e-mails are received from the system one 210.

Thus, in the checking in step S64, it is determined that the system two 220 receives the first id's in different system of series that respectively coincide with all the first id's in different system of series stored in the database 223 from the other system one 210 and, in addition, the second id's in different system of series that respectively coincide with all the second id's in different system of series stored in the database 223 are received from the other system one 210. In this case, the process returns to step S62, and, thereafter, steps S62 to S64 are repeatedly executed until it is determined in step S64 to be the “omitted” state.

Next, it is assumed that under abnormal conditions, that is, when one of the system one 210 and the system two 220 is in shutdown because of some reasons, and is not able to receive e-mails transferred from the mail relay server 100B1 or 100B2.

Here, as an example, it is assumed in the following case. This is the case where the third and fourth e-mails respectively having the second id's in different system of series=s1, s2, s3 are respectively transferred from the mail relay server two 100B2 to the system one 210 and the system two 220. In addition, in this case, the system two 220 temporarily enters the above described shutdown state and, after that, is recovered. That is, it is assumed that, as a result of recovery of the system, among the fourth e-mails having the second id's in different system of series=s1, s2, s3, transferred from the mail relay server two 100B2, only the e-mail having id=s2 is not received by the system two 220.

In this case, the system two 220 stores the received fourth e-mails having the second id's in different system of series=s1, s3 in the database 223 together with the id's=s1, s3 (step S61), and transmits these id's=s1, s3 to the other system one 210 for notification.

On the other hand, during that time, the system one 210 normally operates and, therefore, receives all the third e-mails having the second id's in different system of series=s1, s2, s3, transferred from the mail relay server 100B2. Subsequently, the system one 210 stores the received third e-mails having the id's=s1, s2, s3 in the database 213 together with the id's=s1, s2, s3 (step S51).

Then, the system one 210 checks whether all the second id's in different system of series=s1, s2, s3 that respectively coincide with the second id's in different system of series=s1, s2, s3 stored in the database 213 in this way are received from the other system two 220 (steps S53, S54).

The second id's in different system of series received from the other system two 220 as described above are id's=s1, s3, that is, id=s2 is omitted (missing), so it is determined to be the “omitted” state in the checking in step S54.

In this case, the system one 210 proceeds to step S55, extracts the third e-mail having the missing id=s2 from the database 213, and then transfers the extracted e-mail to the other system two 220.

As a result, in the system two 220, in this way, the third e-mail having the same content as the fourth e-mail having id=s2, which cannot be received from the mail relay server two 100B2 due to the shutdown, is transferred from the system one 210. As a result, the system two 220 compensates for the e-mail having id=s2, which cannot be received due to the shutdown, among the fourth e-mails having id's=s1, s2, s3, transferred from the mail relay server two 100B2.

As a result, the system one 210 holds the third e-mails having the id's=s1, s2, s3, transferred from the mail relay server two 100B2. In addition, the system two 220 holds the fourth e-mails having the id's=s1, s3, transferred from the mail relay server two 100B2. Similarly, the system two 220 holds the third e-mail, which is compensated for by being transferred from the system one 210 as described above and has the same content as the fourth e-mail having id=s2.

Thus, the integrity of the e-mails held by both the system one 210 and the system two 220 is ensured.

Note that in the case of the above assumed example, after the system two 220 recovers from the shutdown, because the e-mails received by both the system one 210 and the system two 220 from the mail relay server two 100B2 or the mail relay server one 100B1, as described above, that is, the third e-mails and the fourth e-mails or the first e-mails and the second e-mails, mutually have the same id's. Thus, the “non-omitted” state is maintained, and, therefore, steps S52 to S54 are repeatedly executed in the system one 210, and steps S62 to S64 are repeatedly executed in the system two 220.

In the third embodiment, as described above, the load balancer 50 is placed in between, and e-mails from the customer systems are relayed by any one of the two mail relay servers 100B1 and 100B2. With the above configuration, if exactly the same id's are assigned between the two mail relay servers 100B1 and 100B2, the same id may possibly be assigned to different e-mails. If the above situation occurs, when id's of e-mails received by both the system one 210 and the system two 220 are compared with each other in order to ensure the integrity of the e-mails, it is impossible to correctly compare the id's. Thus, it is impossible to ensure the integrity of the e-mails between the system one 210 and the system two 220.

To prevent the above situation, in the third embodiment, as described above, different id's in different system of series, that is, the respective first and second id's in different system of series, are assigned respectively by the two mail relay server one and the mail relay server two.

Specifically, in one of the two mail relay servers, for the purpose of discrimination from the e-mails relayed by the other mail relay server, the character “s” is prefixed to id's (second id's in different system of series) and no character is prefixed to id's in the other mail relay server (first id's in different system of series).

As a result, it is possible to avoid the situation in which id's overlap between the e-mails that are respectively relayed by the two mail relay servers. Thus, when mutually comparing the id's of the e-mails that are received by both the system one 210 and the system two 220 in order to ensure the integrity of the e-mails between the system one 210 and the system two 220, the comparison may be correctly performed. That is, it is possible to reliably ensure the integrity of the e-mails between the system one 210 and the system two 220.

Note that in the third embodiment, the number of mail relay servers to which the load balancer 50 distributes e-mails is two. However, it is not limited to only two servers. Instead, the number of mail relay servers to which the load balancer 50 distributes e-mails may be three or more. In that case, id's assigned by each mail relay server are set in accordance with mutually different systems so that id's do not overlap between the e-mails that are respectively relayed by the three or more mail relay servers.

In addition, in the configuration in which any one of the plurality of mail relay servers relays e-mails in this way, a method for setting mutually different id's in different system of series in order to avoid overlapping id's between the plurality of mail relay servers is not limited to the method, such as affixing the character “s” as described above.

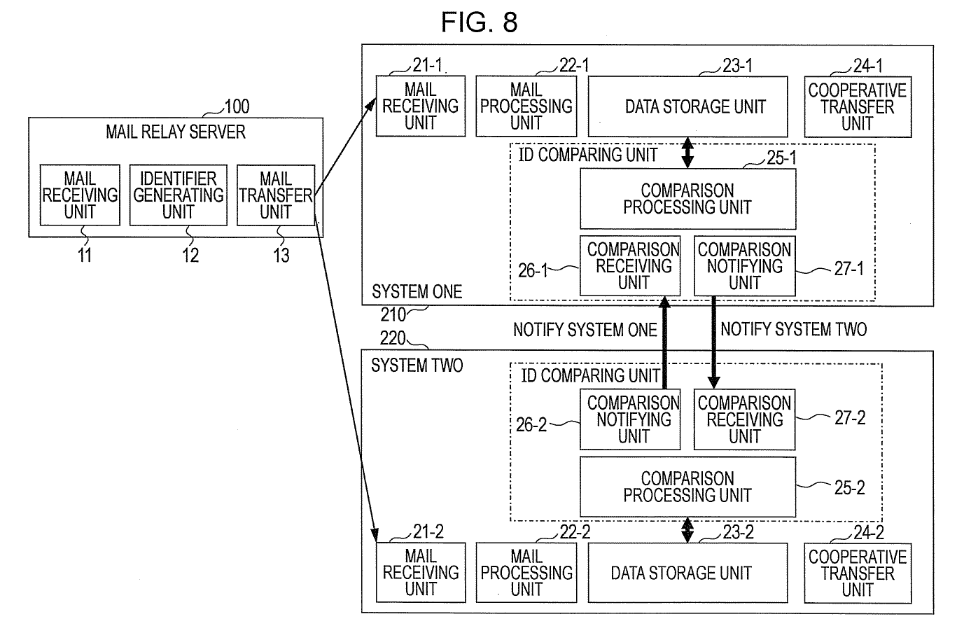

The internal configuration of the components in the embodiments will be described with reference to FIG. 8 to FIG. 10.

FIG. 8 is a block diagram that illustrates the internal configuration that implements the e-mail relay system and method of controlling an e-mail relay system according to the first embodiment.

As depicted in FIG. 8, the mail relay server 100 includes a mail receiving unit 11, an identifier generating unit 12 and a mail transfer unit 13.

In the thus configured mail relay server 100, the mail receiving unit 11 receives e-mails transmitted from the customer systems, and the identifier generating unit 12 generates the identifiers id's assigned to the received e-mails and then adds the identifiers id's to the headers of the e-mails. Then, in the mail transfer unit 13, two e-mails, that is, the first e-mail and the second e-mail, having the same content and the same identifiers id's generated by the identifier generating unit 12 and added to the headers are transferred respectively to the system one 210 and the system two 220.

The system one 210 and the system two 220 respectively include mail receiving units 21-1 and 21-2, mail processing units 22-1 and 22-2, data storage units 23-1 and 23-2, cooperative transfer units 24-1 and 24-2, comparison processing units 25-1 and 25-2, comparison receiving units 26-1 and 26-2, and comparison notifying units 27-1 and 27-2.

In each system 210 or 220, the mail receiving unit 21-1 or 21-2 receives e-mails from the mail relay server 100, the mail processing unit 22-1 or 22-2 analyzes the content of the e-mails, and then stores the e-mails and the id's attached to their headers in the data storage unit 23-1 or 23-2.

The comparison notifying unit 27-1 or 27-2 transfers the id's of the e-mails stored in the data storage unit 23-1 or 23-2 in this way to the other system 220 or 210, and the comparison receiving unit 26-1 or 26-2 receives the id's transmitted from the other system 220 or 210.

The comparison processing unit 25-1 or 25-2 compares the id's stored in the data storage unit 23-1 or 23-2 with the id's of the e-mails received by the other system 220 or 210 from the comparison receiving unit 26-1 or 26-2. Thus, each of the system one 210 and the system two 220 checks whether all id's that respectively coincide with the id's of the e-mails received by itself are included in the id's of the e-mails received by the other system, transmitted from the other system.

As a result of this checking, when at least any one of id's that respectively coincide with the id's of the e-mails received by itself is not included in the id's of the e-mails received by the other system, an e-mail having the id that coincides with the id that is not included in the id's of the e-mails received by the other system is extracted from the data storage unit 23-1 or 23-2 and transferred to the other system by the cooperative transfer unit 24-1 or 24-2.

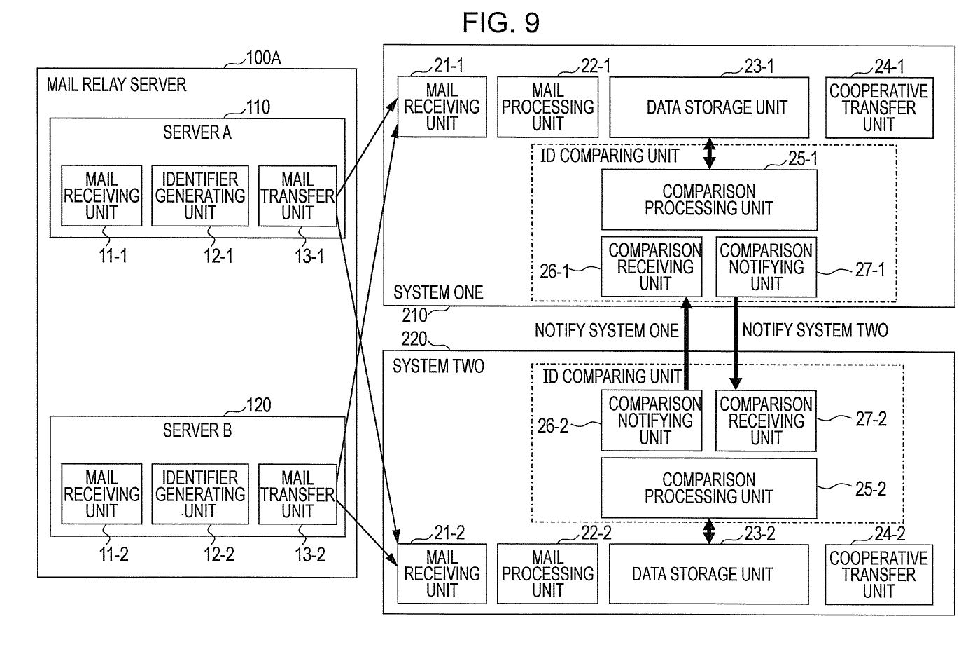

FIG. 9 is a block diagram that illustrates the internal configuration that implements the e-mail relay system and method of controlling an e-mail relay system according to the second embodiment.

In the second embodiment, as depicted in FIG. 9, the mail relay server 100A includes the server A 110 and the server B 120, and these server A 110 and server B 120 respectively include mail receiving units 11-1 and 11-2, identifier generating units 12-1 and 12-2 and mail transfer units 13-1 and 13-2.

These mail receiving units 11-1 and 11-2, identifier generating units 12-1 and 12-2 and mail transfer units 13-1 and 13-2 respectively have similar configurations and similar functions to those of the mail receiving unit 11, identifier generating unit 12 and mail transfer unit 13 according to the first embodiment described with reference to FIG. 8, so the overlapping description is omitted.

In addition, the systems 210 and 220 have similar configurations and similar functions to those of the systems 210 and 220 of the first embodiment described with reference to FIG. 8. Like reference numerals denote the corresponding components, and the overlapping description is omitted.

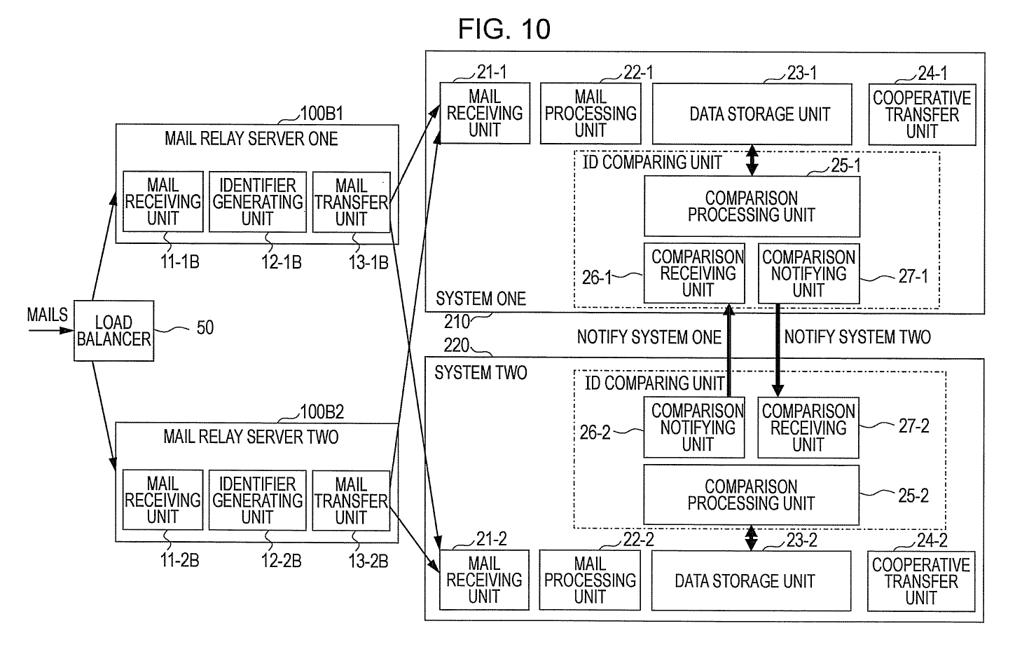

FIG. 10 is a block diagram that illustrates the internal configuration that implements the e-mail relay system and method of controlling an e-mail relay system according to the third embodiment.

In the third embodiment, as depicted in FIG. 10, two mail relay servers 100B1 and 100B2 are provided, and these two mail relay servers 100B1 and 100B2 share and relay e-mails.

The mail relay servers 100B1 and 100B2 respectively include mail receiving units 11-1B and 11-2B, identifier generating units 12-1B and 12-2B and mail transfer units 13-1 B and 13-2B.

These mail receiving units 11-1B and 11-2B, identifier generating units 12-1B and 12-2B and mail transfer units 13-1B and 13-2B respectively have similar configurations and similar functions to those of the mail receiving unit 11, identifier generating unit 12 and mail transfer unit 13 of the first embodiment described with reference to FIG. 8, so the overlapping description is omitted.

However, as described above, in the third embodiment, id's assigned to e-mails that are relayed by the respective mail relay servers 100B1 and 100B2 need to have different id's in different system of series that can be discriminated between the mail relay servers.

In the example depicted in FIG. 6, the identifier generating unit 12-1B of the mail relay server one 100B1 assigns id's=1, 2, 3, 4, 5, . . . (first id's in different system of series) as sequential numbers, and the identifier generating unit 12-2B of the mail relay server two 100B2 assigns id's=s1, s2, s3, s4, s5, . . . (second id's in different system of series) with “s” prefixed to the sequential numbers so that they can be discriminated from the first id's in different system of series.

In addition, the systems 210 and 220 have similar configurations and similar functions to those of the systems 210 and 220 described with reference to FIG. 8. Like reference numerals denote the corresponding components, and the overlapping description is omitted.

However, in the case of the third embodiment, as described above, in each of the comparison processing units 25-1 and 25-2, in regard to the above different id's in different system of series, that is, the first id's in different system of series and the second id's in different system of series, the first id's in different system of series are compared with each other, and the second id's in different system of series are compared with each other. Thus, the presence of a missing e-mail in any one of the systems is checked.

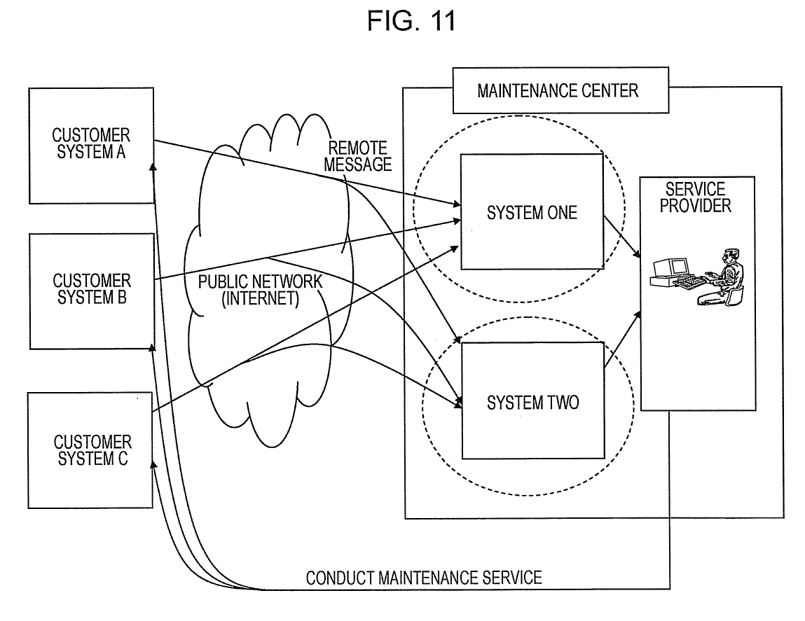

FIG. 11 is a block diagram that illustrates a maintenance management system to which the e-mail relay system and method of controlling an e-mail relay system according to the embodiments may be applied.

As depicted in FIG. 11, the maintenance management system includes a customer system A, a customer system B and a customer system C, which are maintenance management targets, and a maintenance center that maintains and manages these customer systems.

In the maintenance management center, a system one and a system two that respectively correspond to the system one 210 and the system two 220 according to the embodiments are installed, and these system one and system two are connected to the customer systems through a public network, such as the Internet.

In the thus configured maintenance management system, each customer system is provided with a notification function for notifying information that indicates the current status of the customer system, and the notification function transmits information that indicates the current status of the customer system to the system one and the system two of the maintenance management center in means of e-mail.

When the system one and the system two receive the transmitted notification of information that indicates the current status of the customer system by means of e-mail, the content thereof is presented to a service provider. The service provider understands the current status of each customer system in this way, and, where preferable, conducts various maintenance services, such as arrangement of a maintenance person for the customer system or contact with the customer.

The above maintenance management center needs to understand the status of each customer system 24 hours a day, 365 days a year. On the other hand, in the system one and the system two, which serve as the information processing apparatuses that receive e-mails from the customer systems and perform information processing, it is assumed that, for the purpose of maintenance of hardware, revision of firmware, or the like, as described above, a system shutdown may be preferable. Even in that case, to prevent interruption of understanding of the status of each customer system, the system one and the system two are configured to form a duplexed system.

Then, the integrity of e-mails held respectively by the system one and the system two is checked. Thus, it is possible to confirm that e-mails transmitted from the customer systems are reliably received and held and, therefore, it is possible to ensure reliability of maintenance management work in the maintenance management center.

In the maintenance management center, there may be a case where one of the duplexed system one and system two shuts down and, therefore, cannot receive e-mails from the customer systems, causing the integrity of the e-mails held by the system one and the system two to collapse temporarily. In this case as well, the maintenance management center, to which the e-mail relay system and method of controlling an e-mail relay system according to the embodiments of the invention are applied, automatically detects the collapsed integrity by the procedure as described with reference to FIG. 3 to FIG. 10, and compensates for a missing e-mail in any one of the systems. Thus, the integrity is automatically ensured.

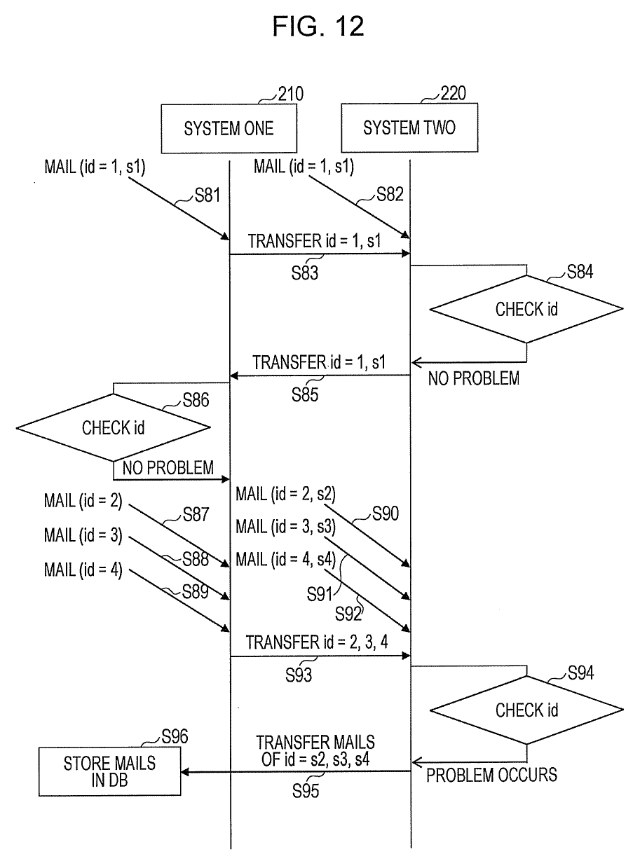

FIG. 12 is a sequence diagram that illustrates a specific example of the exchange of information between the system one 210 and the system two 220 in the above embodiments.

In FIG. 12, in steps S81 and S82, it is assumed that the systems 210 and 220 receive e-mails transferred from the mail relay server, and acquires the id's=1, s1.

In step S83, the system one 210 transmits the id's=1, s1, acquired from thee-mails received by itself, to the system two 220.

Receiving these id's, the system two 220 compares the id's=1, s1 of the e-mails received from the mail relay server by itself with the id's=1, s1 received from the system one 210 in step S83 (step S84).

As a result, both id's coincide with each other. Subsequently, the system two 220 transmits the id's=1, s1, acquired from the e-mails received by itself, to the system one 210 (step S85).

Receiving these id's, the system one 210 compares the id's=1, s1 of the e-mails received from the mail relay server by itself with the id's=1, s1 received from the system two 220 in step S85 (step S86).

As a result, both id's coincide with each other. Thereafter, the system one 210 and the system two 220 wait for further e-mails transmitted from the mail relay server.

After that, it is assumed that the system one 210 receives an e-mail having id=2 (step S87), receives an e-mail having id=3 (step S88), and then receives an e-mail having id=4 (step S89), from the mail relay server.

On the other hand, it is assumed that the system two 220 receives e-mails id's=2, s2 (step S90), receives e-mails having id's=3, s3 (step S91) and then receives e-mails having id's=4, s4 (step S92), from the mail relay server.

In this case, all the e-mails respectively having id's=2, s2, 3, s3, 4, s4, relayed by the mail relay server, are transmitted to the system one 210; however, the e-mails respectively having id's=s2, s3, s4 are not received by the system one 210 for some reasons, and only the e-mails having id's=2, 3, 4 are received.

In this case, in step S93, the system one 210 transmits id's=2, 3, 4, acquired from the e-mails received by itself, to the system two 220.

Receiving these id's, the system two 220 compares the id's=2, s2, 3, s3, 4, s4 of the e-mails received from the mail relay server by itself with the id's=2, 3, 4 received from the system one 210 in step S93 (step S94). As a result, the system two 220 recognizes that, among the id's of the e-mails received by itself, id's=s2, s3, s4 are not included in the id's=2, 3, 4 received from the system one 210.

As a result, the system two 220 extracts the e-mails having these missing id's=s2, s3, s4 from its own database, and transmits the extracted e-mails to the system one 210 (step S95).

The system one 210 stores the transmitted e-mails having id's=s2, s3, s4 in the database (step S96).

As a result, the system one 210 compensates for the e-mails respectively having id's=s2, s3, s4, which cannot be received for some reasons as described above, by the e-mails transferred from the system two 220. Thus, the content of the e-mails held by both systems 210 and 220 is the e-mails respectively having id's=2, s2, 3, s3, 4, s4, and the e-mails received by both the system one 210 and the system two 220 match with each other.

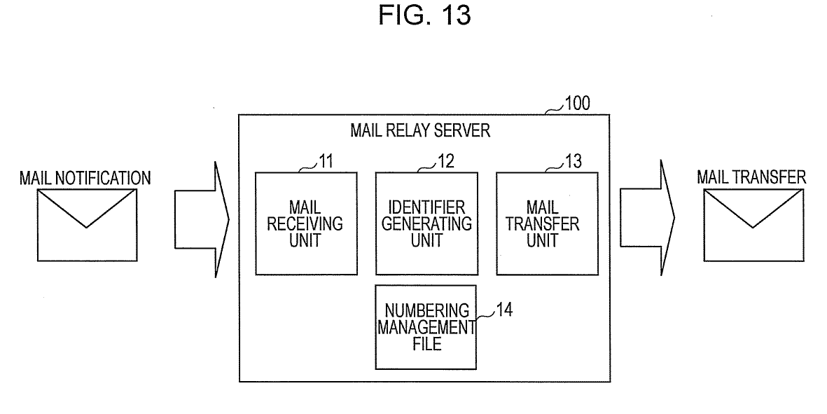

FIG. 13 is a block diagram that illustrates the details of a method of assigning identifiers id's by the mail relay server according to the embodiments.

As described above, in the mail relay server, the identifier generating unit 12 (or 12-1, 12-2 or 12-1B, 12-2B) assigns the identifiers id's to the e-mails received by the mail receiving unit 11 (or 11-1, 11-2 or 11-1B, 11-2B) from the customer systems. The mail relay server assigns the identifiers id's to the e-mails and transmits the e-mails to the systems 210 and 220 by the mail transfer unit 13 (or 13-1, 13-2 or 13-1B, 13-2B).

Here, a method of numbering the identifiers id's in the identifier generating unit 12 (or 12-1, 12-2 or 12-1B, 12-2B) is, for example, as follows.

That is, when, in a first step, the identifier generating unit 12 receives an e-mail from the mail receiving unit 11, in a second step, the identifier generating unit 12 acquires the latest identifier number from a numbering management file 14 of prepared identifier numbers.

Subsequently, in a third step, the identifier generating unit 12 adds the identifier number acquired in the second step to the header of the e-mail acquired in the first step.

Then, in a fourth step, the identifier generating unit 12 increments the identifier number acquired in the second step by one, and additionally writes the incremented number to the numbering management file 14.

Note that the initial value of the identifier number is 1.

In addition, in the case of the third embodiment, in order to be able to identify the mail relay server that has relayed an e-mail as described above, the system of id's is varied by prefixing a unique character in the identifiers id's. As a result, unique identifier numbers may be obtained for each mail relay server.

In addition, the identifier numbers are numbered in accordance with a periodical numbering system, that is, numberable numbers are finite, and, when reaching the upper limit, it returns to 1.

Specifically, for example, the data size of identifier numbers is set to 9 bytes, the leading one digit is used for a unique character in order to identify the mail relay server, and the other eight digits are used for periodical and sequential numbers.

In the case of this example, because periodical and sequential portion is set to 8 bytes, so numbering up to “99999999” is possible.

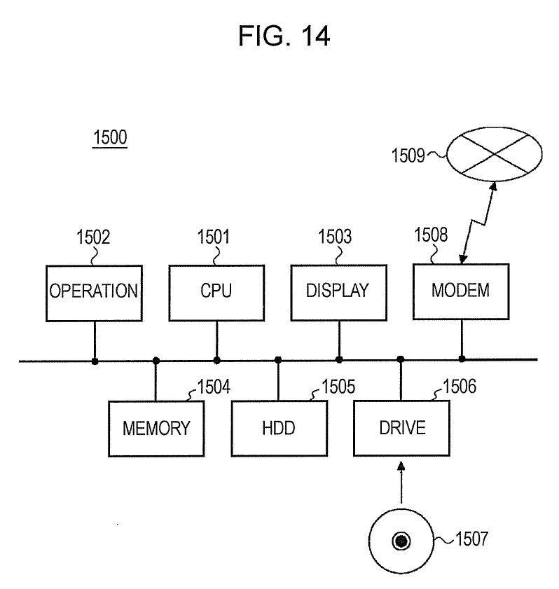

FIG. 14 is a block diagram that depicts a configuration example of a computer, illustrating the case where each of the mail relay server, the system 210 and the system 220 used in the configuration that implements the e-mail relay system and method of controlling the e-mail relay system according to the embodiments of the invention is implemented by the computer.

As depicted in FIG. 14, the computer 1500 includes a CPU 1501 and an operating unit 1502. The CPU 1501 is used to execute various operations by executing instructions described in a given program. The operating unit 1502 is formed of a keyboard, a mouse, or the like, and is used by the user to input operation content or data. The computer 1500 further includes a display unit 1503 and a memory 1504. The display unit 1503 is formed of a CRT, a liquid display, or the like, that displays the progress, result, and the like, processed by the CPU 1501 for the user CPU 1501. The memory 1504 is formed of a ROM, RAM, or the like, and is used to store a program, data, and the like, executed by the CPU 1504 or used as a working area. The computer 1500 further includes a hard disk drive 1505 and a CD-ROM drive 1506. The hard disk drive 1505 stores programs, data, and the like. The CD-ROM drive 1506 loads a program or data from the outside via a CD-ROM 1507. The computer 1500 further includes a modem 1508 that, for example, downloads a program from an external server through a communication network 1509, such as the Internet or LAN.

The computer 1500 loads or downloads a program via the CD-ROM 1507 or via the communication network 1509. Here, the program has instructions for causing the CPU 1501 to execute operations executed by each of the mail relay server, system 210 and system 220 in the configuration that implements the e-mail relay system and method of controlling an e-mail relay system according to the embodiments of the invention described with reference to FIG. 3 to FIG. 10. Then, the computer 1500 installs the program on the hard disk drive 1505, and loads the program on the memory 1504 as needed, then the CPU 1501 executes the program. As a result, the computer 1500 implements the functions of each of the mail relay server, system 210 and system 220.

Note that in the above embodiments, in each of the systems 210 and 220, using the id's of the e-mails received from the mail relay server by itself and stored in its own database as a reference, id's of the e-mails received from the mail relay server by the other system, and then the id's transmitted from the other system are checked; however, it is not necessarily limited to this configuration.

That is, in each of the systems 210 and 220, using the id's of the e-mails received from the mail relay server by the other system and transmitted from the other system as a reference, id's of the e-mails are received from the mail relay server by itself, and then the id's stored in its own database may be checked. In the case of the above configuration, in the system 210 or 220, when at least any one of id's that respectively coincide with the id's of the e-mails notified from the other system is not included in the id's of the e-mails received from the mail relay server by itself and stored in its own database, the operation may be as follows. That is, the system 210 or 220 needs the e-mail having the omitted id, that is, the missing e-mail, to be transmitted from the other system. Thus, the system 210 or 220 requests the other system to transmit the missing e-mail. Then, when the corresponding e-mail is received from the other system, the system 210 or 220 stores the e-mail in its own database. As a result, it is possible to ensure the integrity of the e-mails held by both systems.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An e-mail relay system, comprising:
a first information processing apparatus;
a second information processing apparatus; and
a relay apparatus that receives one or more first e-mails with one or more respective first identifiers and relays the one or more first e-mails to the first information processing apparatus, and receives one or more second e-mails that are identical to the one or more first emails and have one or more second identifiers that are identical to the one or more first identifiers and relays the one or more second e-mails to the second information processing apparatus, wherein
the first information processing apparatus receives the one or more first e-mails with the one or more first identifiers, stores the received one or more first e-mails in a first storage device, and notifies the one or more first identifiers to the second information processing apparatus, and
the second information processing apparatus receives the one or more second e-mails with the one or more second identifiers, stores the received one or more second e-mails in a second storage device with the one or more second identifiers, compares the one or more first identifiers notified by the first information processing apparatus with the one or more second identifiers stored in the second storage device, and extracts a second e-mail having a second identifier that is the same as an unnotified first identifier from the second storage device and then transfers the extracted second e-mail to the first information processing apparatus.

2. The e-mail relay system according to claim 1, wherein the second information processing apparatus notifies the one or more second identifiers of the received one or more second e-mails to the first information processing apparatus, and
the first information processing apparatus stores the one or more first identifiers of the received one or more first e-mails, compares the one or more second identifiers notified by the second information processing apparatus with the one or more first identifiers stored in the first storage device, and extracts a first e-mail having a first identifier that is the same as un unnotified second identifier from the first storage device and then transfers the extracted first e-mail to the second information processing apparatus.

3. The e-mail relay system according to claim 1, wherein
the relay apparatus includes mutually duplexed first and second relay apparatuses, and
when the first relay apparatus stops relaying e-mails, the second relay apparatus starts relaying e-mails.

4. The e-mail relay system according to claim 1, wherein each of the one or more first identifiers and each of the one or more second identifiers are sequential.

5. An e-mail relay system, comprising:
a first information processing apparatus;
a second information processing apparatus;
a load balancer that distributes and relays received e-mails;
a first relay apparatus that receives one or more first e-mails from the load balancer, and relays the received one or more first e-mails with one or more respective first identifiers, indicating that the first relay apparatus has received the one or more first e-mails, to the first information processing apparatus, and receives one or more second e-mails from the load balancer, and relays the one or more second e-mails to the second information processing apparatus, the one or more second e-mails being identical to the one or more first emails and having one or more second identifiers that are identical to the one or more first identifiers; and
a second relay apparatus that receives one or more third e-mails from the load balancer, and relays the received one or more third e-mails with one or more respective third identifiers, indicating that the second relay apparatus has received the one or more third e-mails, to the first information processing apparatus, and receives one or more fourth e-mails from the load balancer, and relays the one or more fourth e-mails to the second information processing apparatus, the one or more fourth e-mails being identical to the one or more third emails and having one or more fourth identifiers that are identical to the one or more third identifiers, wherein
the first information processing apparatus receives the one or more first e-mails with the one or more first identifiers and the one or more third e-mails with the one or more third identifiers and stores the one or more first and the one or more third e-mails in a first storage device, and notifies the one or more first identifiers and the one or more third identifiers to the second information processing apparatus, and
the second information processing apparatus receives the one or more second e-mails with the one or more second identifiers and stores the received one or more second e-mails in a second storage device with the one or more second identifiers, and compares the one or more first identifiers of the one or more first e-mails notified by the first information processing apparatus with the one or more second identifiers of the one or more second e-mails stored in the second storage device, and extracts a second e-mail having a second identifier that is the same as an unnotified first identifier of a first e-mail from the second storage device and then transfers the extracted second e-mail to the first information processing apparatus.

6. The e-mail relay system according to claim 5, wherein the second information processing apparatus receives the one or more fourth e-mails with the one or more fourth identifiers and stores the one or more fourth e-mails in the second storage device, and compares the one or more third identifiers of the one or more third e-mails notified by the first information processing apparatus with the one or more fourth identifiers of the one or more fourth e-mails stored in the second storage device, and extracts a fourth e-mail having a fourth identifier that is the same as an unnotified third identifier of a third e-mail from the second storage device and then transfers the extracted fourth e-mail to the first information processing apparatus.

7. The e-mail relay system according to claim 5, wherein
the second information processing apparatus notifies the first information processing apparatus of the one or more second identifiers of the received one or more second e-mails, and
the first information processing apparatus stores the one or more first identifiers of the received one or more first e-mails, compares the one or more second identifiers of the one or more second e-mails notified by the second information processing apparatus with the one or more first identifiers of the one or more first e-mails stored in the first storage device, and extracts a first e-mail having a first identifier that is the same as an unnotified second identifier of a second e-mail from the first storage device and then transfers the extracted first e-mail to the second information processing apparatus.

8. The e-mail relay system according to claim 5, wherein
the second information processing apparatus notifies the first information processing apparatus of the one or more fourth identifiers of the received one or more fourth e-mails, and
the first information processing apparatus stores the one or more third identifiers of the received one or more third e-mails, compares the one or more fourth identifiers of the one or more fourth e-mails notified by the second information processing apparatus with the one or more third identifiers of the one or more third e-mails stored in the first storage device, and extracts a third e-mail having a third identifier that is the same as an unnotified fourth identifier of a fourth e-mail from the first storage device and then transfers the extracted third e-mail to the second information processing apparatus.

9. The e-mail relay system according to claim 5, wherein each of the first, second, third, and fourth identifiers are respectively sequential.

10. A method of controlling an e-mail relay system including a relay apparatus that relays received e-mails and first and second information processing apparatuses connected to the relay apparatus, the method comprising:
relaying one or more first e-mails to the first information processing apparatus with one or more respective first identifiers;
relaying one or more second e-mails to the second information processing apparatus with one or more respective second identifiers;
receiving the one or more first e-mails and storing the one or more first e-mails in a first storage device, and notifying the one or more first identifiers to the second information processing apparatus by the first information processing apparatus;
receiving the one or more second e-mails and storing the one or more second e-mails in a second storage device with the one or more second identifiers;
comparing the one or more first identifiers notified by the first information processing apparatus with the one or more second identifiers stored in the second storage device;
extracting a second e-mail having a second identifier that is the same as an unnotified first identifier from the second storage device; and
transferring the extracted second e-mail to the first information processing apparatus by the second information processing apparatus.

11. The method of controlling an e-mail relay system according to claim 10, further comprising:
notifying the one or more second identifiers to the first information processing apparatus;
storing the one or more first identifiers with the one or more first e-mails in the first storage device;
comparing the one or more second identifiers notified by the second information processing apparatus with the one or more first identifiers stored in the first storage device;
extracting a first e-mail having a first identifier that is the same as an unnotified second identifier from the first storage device; and
transferring the extracted first e-mail to the second information processing apparatus.

12. The method of controlling an e-mail relay system according to claim 10, wherein the relay apparatus includes mutually duplexed first and second relay apparatuses, the method further comprising:
starting relaying e-mails by the second relay apparatus when the first relay apparatus stops relaying e-mails.

13. The method of controlling an e-mail relay system according to claim 10, wherein each of the first and second identifiers are sequential.

14. A method of controlling an e-mail relay system including a load balancer that distributes and relays received e-mails, a first relay apparatus that relays the e-mails relayed to the first relay apparatus by the load balancer, a second relay apparatus that relays e-mails, other than the e-mails relayed by the first relay apparatus, from among the e-mails relayed by the load balancer, and first and second information processing apparatuses that are connected to both the first and second relay apparatuses, the method comprising:
relaying one or more first e-mails by the first relaying apparatus to the first information processing apparatus with one or more first identifiers indicating that the first relay apparatus has received;
relaying one or more second e-mails by the first relay apparatus to the second information processing apparatus which are the received e-mails with the one or more first identifiers that are the same as the first identifiers of the first e-mails;
relaying one or more third e-mails by the first relay apparatus to the first information processing apparatus received from the load balancer with one or more second identifiers indicating that the second relay apparatus has received;
relaying one or more fourth e-mails by the second relay apparatus to the second information processing apparatus received from the load balancer with one or more second identifiers indicating that the second relay apparatus has received;
receiving the one or more first and one or more third e-mails by the first information processing apparatus;
storing the one or more first and one or more third e-mails in a first storage device of the first information processing apparatus;
notifying the one or more first identifiers of the received one or more first e-mails and the one or more second identifiers of the received one or more third e-mails to the second information processing apparatus, by the first information processing apparatus;
receiving the one or more second e-mails and storing the one or more second e-mails with the one or more first identifiers of the one or more second e-mails in a second storage device of the second information processing apparatus;
comparing the one or more first identifiers of the one or more first e-mails notified by the first information processing apparatus with the one or more first identifiers of the one or more second e-mails stored in the second storage device;
extracting one or more second e-mails having first identifiers that are the same as unnotified first identifiers of the one or more first e-mails from the second storage device; and
transferring the extracted one or more second e-mails to the first information processing apparatus by the second information processing apparatus.

15. The method of controlling an e-mail relay system according to claim 14, further comprising:
receiving the one or more fourth e-mails by the first information processing apparatus;
storing the one or more fourth e-mails with the one or more second identifiers of the one or more fourth e-mails in the second storage device of the second information processing apparatus;
comparing the one or more second identifiers of the one or more third e-mails notified by the first information processing apparatus with the one or more second identifiers of the one or more fourth e-mails stored in the second storage device;
extracting one or more fourth e-mails having second identifiers that are the same as unnotified second identifiers of the one or more third e-mails from the second storage device; and
transferring the extracted one or more fourth e-mails to the first information processing apparatus, by the second information processing apparatus.

16. The method of controlling an e-mail relay system according to claim 14, further comprising:
notifying the first information processing apparatus of the one or more first identifiers of the received one or more second e-mails by the second information processing apparatus;
storing the one or more first identifiers of the one or more first e-mails together with the one or more first e-mails in the second storage device of the second information processing apparatus;
comparing the first identifiers of the second e-mails notified by the second information processing apparatus with the first identifiers of the first e-mails stored in the first storage device;
extracting one or more first e-mails having first identifiers that are the same as unnotified first identifiers of the one or more second e-mails from the first storage device; and
transferring the extracted one or more first e-mails to the second information processing apparatus, by the first information processing apparatus.

17. The method of controlling an e-mail relay system according to claim 14, further comprising:
notifying the first information processing apparatus of the one or more second identifiers of the received one or more fourth e-mails by the second information processing apparatus;
storing the one or more second identifiers of the one or more third e-mails together with the one or more third e-mails in the second storage device of the second information processing apparatus;
comparing the one or more second identifiers of the one or more fourth e-mails notified by the second information processing apparatus with the one or more second identifiers of the one or more third e-mails stored in the first storage device,
extracting one or more third e-mails having second identifiers that are the same as unnotified second identifiers of the one or more fourth e-mails from the first storage device; and
transferring the extracted one or more third e-mails to the second information processing apparatus, by the first information processing apparatus.

18. The method of controlling an e-mail relay system according to claim 14, wherein the first and second identifiers are respectively sequential.
